(19) United States
(12) Patent Application Publication
(10) Pub. No.: US 2026/0360187 A1
(43) Pub. Date: Nov. 12, 2026

(54) LIVENESS DETECTION AND MODEL TRAINING

(71) Applicant: MASHANG CONSUMER FINANCE CO., LTD., Chongqing (CN)

(72) Inventor: Yanhong LIU, Chongqing (CN)

(73) Assignee: MASHANG CONSUMER FINANCE CO., LTD., Chongqing (CN)

(21) Appl. No.: 19/438,345

(22) Filed: Dec. 31, 2025

(30) Foreign Application Priority Data
May 7, 2025 (CN) 202510586776.4

(51) Int. Cl. G06V 40/40; G06V 10/25; G06V 10/80

(52) U.S. Cl. CPC G06V 40/45; G06V 10/25; G06V 10/806

(57) ABSTRACT

A liveness detection method includes: performing feature extraction on one or more image frames of a detected object to obtain a first feature and determining a first liveness detection result for the detected object based on the first feature, where the image frames are obtained by acquiring an image of the detected object while changing a position thereof; performing feature extraction on a first time-frequency diagram of a first acoustic wave signal, formed by the detected object reflecting a second acoustic wave signal while changing the position thereof, to obtain a second feature, and determining a second liveness detection result for the detected object based on the second feature; fusing the first and second features based on the first and second liveness detection results to obtain a third feature; and determining a third liveness detection result for the detected object based on the third feature.

### CROSS-REFERENCE TO RELATED APPLICATION

This application claims priority to and the benefit of Chinese Patent Application No. 202510586776.4, filed on May 7, 2025, the disclosure of which is incorporated herein by reference in its entirety.

### TECHNICAL FIELD

The present disclosure relates to liveness recognition technologies, and more particularly, to liveness detection, and model training.

### BACKGROUND

The liveness detection technology has been widely applied to diverse scenarios such as financial payments, intelligent access control, smart homes, and terminal unlocking. With the liveness detection technology, it is possible to verify whether a detected object is alive, thereby resisting attacks such as a print attack and a replay attack, and ensuring secure digital identity authentication.

Generally, the liveness detection technology is susceptible to factors such as an environment where an object is detected, and the stability of the detection device, resulting in low accuracy, robustness and generalization capability of detection.

### SUMMARY

In a first aspect, a liveness detection method according to some embodiments of the present disclosure includes: performing feature extraction on one or more image frames of a detected object to obtain a first feature and determining a first liveness detection result for the detected object based on the first feature, where the one or more image frames are obtained by acquiring an image of the detected object during a process of changing a position of the detected object; performing feature extraction on a first time-frequency diagram of a first acoustic wave signal to obtain a second feature and determining a second liveness detection result for the detected object based on the second feature, where the first acoustic wave signal is formed by the detected object reflecting a second acoustic wave signal during the process of changing the position of the detected object; fusing the first feature and the second feature based on the first liveness detection result and the second liveness detection result to obtain a third feature; and determining a third liveness detection result for the detected object based on the third feature.

In a second aspect, a model training method according to some embodiments of the present disclosure includes: performing feature extraction on one or more image frames of a sample object to obtain a first feature and determining a first liveness detection result for the sample object based on the first feature, where the one or more image frames are obtained by acquiring an image of the sample object during a process of changing a position of the sample object; performing feature extraction on a first time-frequency diagram of a first acoustic wave signal to obtain a second feature and determining a second liveness detection result for the sample object based on the second feature, where the first acoustic wave signal is formed by the sample object reflecting a second acoustic wave signal during the process of changing the position of the sample object; fusing the first feature and the second feature based on the first liveness detection result and the second liveness detection result to obtain a third feature; determining a third liveness detection result for the sample object based on the third feature; and adjusting a parameter of a liveness detection model based on the third liveness detection result and a label of the sample object indicating whether the sample object is alive.

In a third aspect, an electronic device according to some embodiments of the present disclosure includes: a processor; and a memory storing instructions executable by the processor to perform the liveness detection method of the first aspect or the model training method of the second aspect.

In a fourth aspect, a non-transitory computer-readable storage medium according to some embodiments of the present disclosure stores instructions executable by a processor of an electronic device to perform the liveness detection method of the first aspect or the model training method of the second aspect.

### BRIEF DESCRIPTION OF THE DRAWINGS

FIG. 1 is a schematic diagram of an implementation environment according to some embodiments of the present disclosure.

FIG. 2 is a schematic flowchart of a liveness detection method according to some embodiments of the present disclosure.

FIG. 3 is a schematic diagram of a method of obtaining image frames according to some embodiments of the present disclosure.

FIG. 4 is a schematic block diagram of a liveness detection model according to some embodiments of the present disclosure.

FIG. 5 schematically shows a first time-frequency diagram according to some embodiments of the present disclosure.

FIG. 6 schematically shows a second time-frequency diagram according to some embodiments of the present disclosure.

FIG. 7 is a schematic flowchart of a model training method according to some embodiments of the present disclosure.

FIG. 8 is a schematic block diagram of a liveness detection apparatus according to some embodiments of the present disclosure.

FIG. 9 is a schematic block diagram of a model training apparatus according to some embodiments of the present disclosure.

FIG. 10 is a schematic block diagram of an electronic device according to some embodiments of the present disclosure.

### DETAILED DESCRIPTION

Some embodiments of the present disclosure will be described in detail below with reference to the accompanying drawings. The embodiments are described for illustrative purposes only and are not intended to limit the present disclosure.

The terms “first”, “second,” etc. in the specification, claims, and accompanying drawings of the present disclosure are used to distinguish similar objects and are not necessarily used to describe a specific order or sequence. It is to be understood that such terms are used interchangeably as appropriate. This is merely a way of distinguishing objects with the same attributes in the embodiments of this application.

Explanation of several terms:

Print attack: An attacker simulates identity verification by playing a pre-recorded video on a screen of a terminal device or by using a photo or the like.

Replay attack: An attacker pre-captures a video for simulating identity verification and then plays back the video to fake an identity in order to pass the verification.

Far-near movement: The detected object moves in a direction perpendicular to the screen of the terminal device.

Through research, the inventor has made discoveries as follows.

In one aspect, in the process of changing the position of the detected object, for example, in the process of changing the distance between the detected object and the terminal device, there is a significant difference in the key point offset between the liveness detected object and the non-liveness detected object. Therefore, it is possible to determine whether the detected object is alive or not based on the key point offset of the detected object. In addition, although this method relies on good image quality and is susceptible to factors such as ambient light and image definition, the key point offset is not sensitive to the identity of the detected object and the signal quality of the terminal device.

In another aspect, an analog device such as a speaker of the terminal device may transmit an acoustic wave signal, and an analog device such as a microphone may receive the acoustic wave signal. In the process of changing the distance between the detected object and the terminal device, under the condition that the detected object is alive, the change in the distance causes the detected object and the terminal device to move relative to each other, thereby causing the frequency of the echo signal reflected by the detected object to be shifted. This phenomenon is referred to as a Doppler shift phenomenon, and may be observed in a time-frequency diagram of the echo signal. Under the condition that the detected object is not alive such as a photograph or a video, the Doppler shift phenomenon does not occur. Therefore, it is possible to determine whether the detected object is alive by determining whether a Doppler shift phenomenon occurs in the echo signal reflected by the detected object. Moreover, although this method is sensitive to the operation stability of the terminal device and the position of the detected object relative to the terminal device, it is not affected by factors such as image acquisition quality.

In yet another aspect, the liveness detection is performed in combination with the above ways, that is, the key point offset of the detected object and the time-frequency diagram of the echo signal reflected by the detected object. In the detection process, according to the actual conditions of various factors such as the condition of the environment in which the detected object is located and the stability of the detection device, a higher weight is assigned to the higher-quality way, and a lower weight is assigned to the lower-quality way, so that the noise effect caused by the lower-quality way may be effectively avoided, and the advantages of each of the above two ways may be fully utilized, so that the liveness detection process is not easily affected by factors such as the environment in which the detected object is located and the stability of the detection device, thereby improving accuracy, robustness and generalization capability of the detection.

In light of the foregoing considerations, some embodiments of the present disclosure provide a liveness detection method. During the process of changing the position of the detected object, not only an image frame of the detected object is acquired, but also a second acoustic wave signal is transmitted to the detected object. Thereafter, on the one hand, the image frame of the detected object is subjected to feature extraction to obtain the first feature, and the first feature may reflect the key point offset of the detected object, so that the first liveness detection result for the detected object may be determined based on the first feature. On the other hand, a first acoustic wave signal reflected by the detected object is received, the feature extraction is performed on the first time-frequency diagram of the first acoustic wave signal to obtain the second feature. Since the first time-frequency diagram may reflect the frequency offset of the first acoustic wave signal, the second liveness detection result for the detected object may be determined based on the second feature. Further, the first liveness detection result may reflect the quality of the first feature, and the second liveness detection result may reflect the quality of the second feature. The third feature is obtained by fusing the first feature and the second feature, and the third detection result for the detected object is determined based on the third feature. Therefore, the low-quality feature may be suppressed, and the high-quality feature is primarily dependent on the third detection result for the detected object. Thus, the advantages of the first feature and the second feature are fully realized, so that the liveness detection process is not easily affected by factors such as the environment in which the detected object is located, the stability of the detection device, and the like, and accuracy, robustness and generalization capability of the detection are significantly improved.

Some embodiments of the present disclosure provide a model training method. During the process of changing the position of the sample object, not only an image frame of the sample object is acquired, but also an acoustic wave signal is transmitted in the direction towards the sample object. Thereafter, on the one hand, the image frame of the sample object is subjected to feature extraction to obtain the first feature, and the first feature may reflect the key point offset of the sample object, so that the first liveness detection result for the sample object may be determined based on the first feature. On the other hand, an echo signal reflected by the sample object is received, the feature extraction is performed on the time-frequency diagram of the echo signal to obtain the second feature. Since the time-frequency diagram may reflect the frequency offset of the first acoustic wave signal, the second liveness detection result for the sample object may be determined based on the second feature. Further, the first liveness detection result may reflect the quality of the first feature, and the second liveness detection result may reflect the quality of the second feature. The third feature is obtained by fusing the first feature and the second feature, and the third detection result for the sample object is determined based on the third feature, the third liveness detection result for the sample object indicates whether the sample object is alive and is used to adjust the parameter of the liveness detection model, so that the liveness detection model may suppress low-quality features and primarily dependent on high-quality features. Thus, the advantages of the first feature and the second feature are fully realized, so that the liveness detection model is not easily affected by factors such as the environment in which the sample object is located, the stability of the detection device, and the like, and the liveness detection model may perform liveness detection robustly and accurately under various an environment and exhibits high generalization capability.

It should be understood that the liveness detection method and the model training method according to some embodiments of the present disclosure may be performed by an electronic device. As an example, the above methods may be executed by software in an electronic device. The electronic devices referred to herein may include terminal devices such as a smartphone, a tablet computer, a laptop computer, a desktop computer, an intelligent voice interaction device, a smart home appliance, a smart watch, a vehicle-mounted terminal, an aircraft, and the like. Alternatively, the electronic device may further include a server, such as a separate physical server, a server cluster, or a distributed system formed by a plurality of physical servers, or a cloud server providing a cloud computing service.

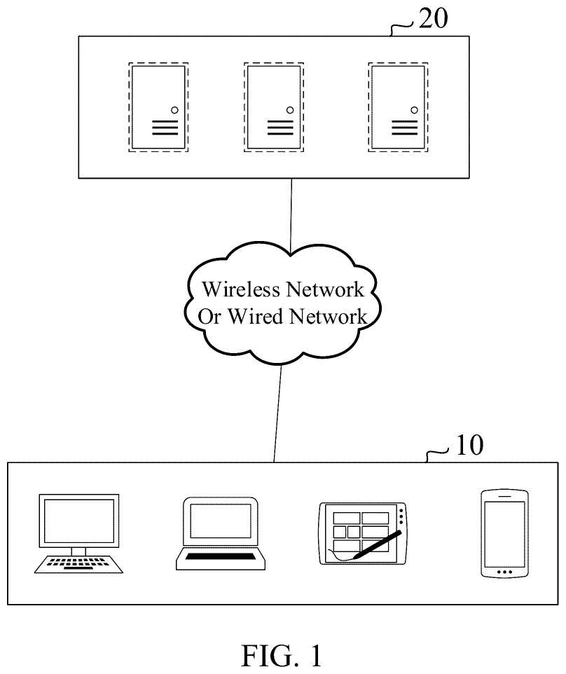

Before a detailed description of the liveness detection method and the model training method according to some embodiments of the present disclosure, the implementation environment related to the embodiments of the present disclosure is briefly described. FIG. 1 shows a schematic diagram of an implementation environment including a terminal device 10 and a server portion 20 according to some embodiments of the present disclosure. The terminal device 10 is connected to the server portion 20 via a wireless network or a wired network.

The terminal device 10 may be at least one of a smartphone, a tablet computer, a laptop computer, a desktop computer, an intelligent voice interaction device, a smart home appliance, a smart watch, a vehicle-mounted terminal, an aircraft, and the like. The terminal 10 may have installed with and run a liveness detection application and further have an image acquisition function and an acoustic wave signal emission function. The liveness detection application may be an application program dedicated to liveness detection, or may be a functional module in other applications, such as a liveness detection module in a payment application.

The server portion 20 includes at least one of a single server, multiple servers, a cloud computing platform, and a virtualization center. The server portion 20 is configured to provide background services for liveness detection applications.

For example, when liveness detection is required, the terminal device 10 displays bounding boxes of different sizes on an interface to instruct the detected object to perform far-near movement or move the terminal device from far to near or from near to far, thereby changing the distance between the detected object and the terminal device. During the process of changing the distance, the terminal device 10 acquires the images of the detected object to obtain image frames of the detected object, and sends the image frames of the detected object to the server portion 20.

In addition, during the period from the time when a first one of the bounding boxes is displayed on the interface to the time when acquisition of all the image frames is completed, the terminal device 10 transmits, through a sound transmitting module such as a speaker, a second acoustic wave signal at a fixed frequency in a direction towards the detected object. The second acoustic wave signal is reflected by the detected object to form the first acoustic wave signal. The first acoustic wave signal is acquired by a sound acquisition module, such as a microphone, of the terminal device 10. The terminal device 10 transmits the first acoustic wave signal to the server portion 20.

On the one hand, the server portion 20 determines whether the detected object is alive by identifying the key point offset of the detected object based on the image frames, and on the other hand, the server portion 20 determines whether the detected object is alive by determining the presence of a Doppler shift phenomenon in the detected object based on the time-frequency diagram of the first acoustic wave signal. Finally, the server portion 20 combines the two liveness detection results to obtain the final liveness detection result for the detected object.

Based on the implementation environment described above, the liveness detection method and the model training method according to some embodiments of the present disclosure will be described in detail below with reference to the accompanying drawings.

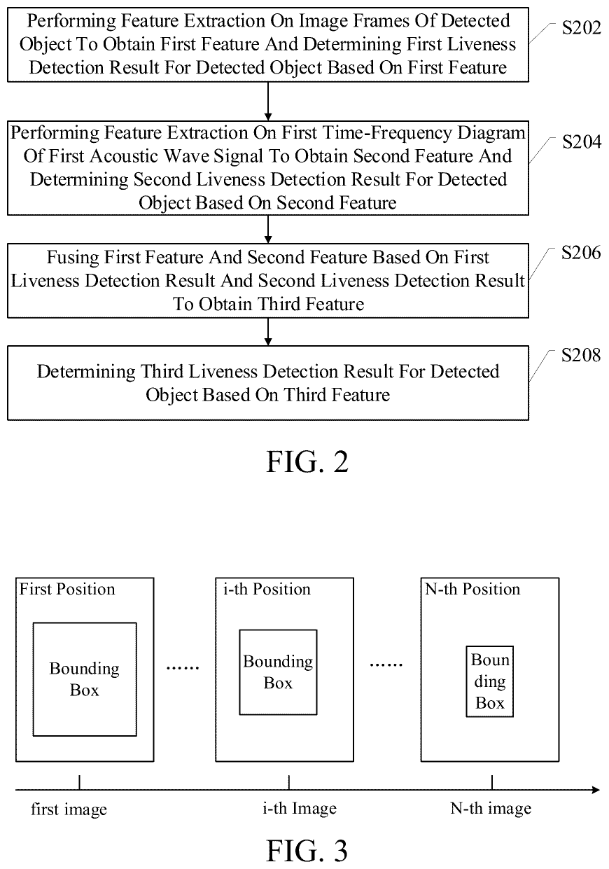

FIG. 2 shows a schematic flowchart of a liveness detection method according to some embodiments of the present disclosure. The liveness detection method includes Step S202 to Step S208.

At Step S202, feature extraction is performed on one or more image frames of a detected object to obtain a first feature, and a first liveness detection result for the detected object is determined based on the first feature.

The detected object refers to an individual undergoing the liveness detection. The detected object may be alive, such as a real face, or may be not alive, such as a facial picture of a user, a facial video, or the like.

Image acquisition is performed on the detected object to obtain the image frame during the process of changing the position of the detected object. The one or more image frames may be plural; that is, a plurality of image frames may be obtained. Each of the plurality of image frames has a corresponding timestamp to represent the acquisition order of the image frame. The plurality of image frames are obtained when the detected object is at different positions, respectively, by the image acquisition performed on the detected object at different positions. Therefore, the image frames may reflect the key point offset of the detected object, thereby helping to accurately determine whether the detected object is alive.

In an application, the change in the position of the detected object may refer to a change in an absolute position of the detected object, or may refer to a change in the relative position of the detected object relative to the terminal device such as the detected object moving closer/farther from the terminal device or the terminal device moving closer/farther from the detected object. This change in the relative position of the detected object causes the change in the distance between the detected object and the terminal device. In this case, the plurality of image frames may be obtained by image acquisition performed on the detected object with the different distances between the detected object and the terminal device, respectively.

The terminal device may be any device having an image acquisition function and an acoustic wave signal emission function. For example, during the process of performing the liveness detection on the detected object, the terminal device displays bounding boxes of different sizes on an interface to instruct the detected object to perform far-near movement or move the terminal device from far to near or from near to far, thereby changing the distance between the detected object and the terminal device. During the process of changing the distance, the terminal device acquires the images of the detected object to obtain image frames of the detected object.

As shown in FIG. 3, after activating the liveness detection function, the terminal device randomly generates N bounding boxes of different sizes, where N is an integer greater than one. The terminal device displays a first bounding box of the N bounding boxes at the interface to instruct the detected object to adjust the distance between the detected object and the terminal device, to ensure that a corresponding region in the interface where the detected object is located is within the bounding box. When the detected object is located at the first position, the distance between the detected object and the terminal device is the first distance. In this case, the region in the interface corresponding to the detected object is located within the first bounding box. It can be seen that the position of the bounding box in the interface is used to indicate the region in the interface corresponding to the detected object, and the size of the bounding box is used to indicate the distance between the detected object and the terminal device.

The terminal device performs the image acquisition on the detected object to obtain the first image frame, and displays the next bounding box. The above process is repeated so that the detected object performs far-near movement with respect to the terminal device. When the detected object moves to the N-th position, the distance between the detected object and the terminal device is the N-th distance and the region in the interface corresponding to the detected object is located in the N-th bounding box, and the terminal device performs image acquisition on the detected object to obtain the N-th image frame. Thus, the terminal device can acquire N image frames of the detected object in total.

In order to more accurately identify the key point offset of the detected object during the process of changing the distance, the performing of the feature extraction on the one or more image frames of the detected object to obtain the first feature at Step S202 may include: extracting first key point data of the detected object from the one or more image frames, respectively; concatenating the first key point data respectively corresponding to the one or more image frames according to an order of respective timestamps of the one or more image frames to obtain second key point data; and performing feature extraction on the second key point data to obtain the first feature.

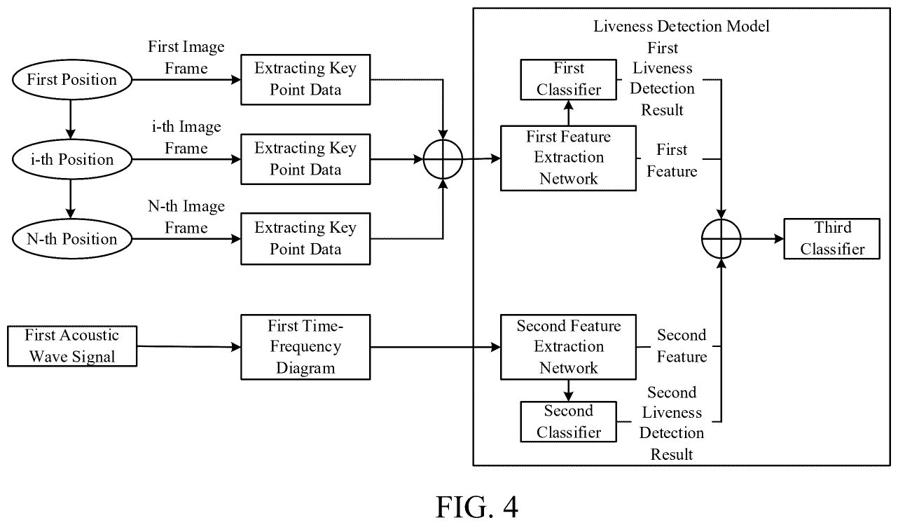

As shown in FIG. 4, the terminal device acquires N image frames of the detected object, performs feature extraction on each image frame to extract first key point data from each image frame, and concatenates the first key point data for the N image frames to obtain a matrix with a size of N×k×2, where the matrix is second key point data, N represents the number of image frames, k represents the number of key points, and 2 represents that there are two kinds of coordinates, i.e., x and y coordinates. Then, the terminal device performs feature extraction on the second key point data by using the first feature extraction network, to obtain the first feature of the detected object. Since the first feature is obtained based on an image frame, it belongs to the category of the image feature.

The key point data may include, but is not limited to, the number of key points, coordinates of each key point, a semantic label, and the like. The semantic label of the key point indicates a body part of the detected object corresponding to the key point, such as a left eye, a nose tip, and a right mouth corner. The extracting of the key point data from each image frame may be implemented by various key point detection algorithms in the art, such as the key point models provided by Dlib, Regression, Heatmap and the like. The first feature extraction network may employ various neural networks having a feature extraction capability, such as a Convolutional Neural Network (CNN) and the like, which is not limited to the embodiments of the present disclosure.

After obtaining the first feature, the first feature is classified to obtain a first liveness detection result for the detected object. The first liveness detection result indicates whether the detected object is alive. For example, the first liveness detection result includes a first score indicating that the detected object is alive and a second score indicating that the detected object is not alive. The greater the first score, the greater the likelihood that the detected object is alive; Similarly, the larger the second score, the greater the likelihood that the detected object is not alive.

The classification of the first feature may be implemented by a liveness detection model. For example, as shown in FIG. 4, the first feature output from the first feature extraction network in the liveness detection model is classified by the first classifier to obtain the first liveness detection result. Here, the first classifier may be a Multilayer Perceptron (MLP). The MLP includes an input layer, a hidden layer, and an output layer with each layer formed by a plurality of neurons. The input layer receives the first feature. The hidden layer performs non-linear transformation on the first feature to obtain the first score indicating that the detected object is alive and the second score indicating that the detected object is not alive, which are also referred to as logits. The output layer converts the first and second scores into a first probability that the detected object is alive and a second probability that the detected object is not alive, respectively. At Step S202, the output result from the hidden layer is determined as the first liveness detection result.

At Step S204, feature extraction is performed on a first time-frequency diagram of a first acoustic wave signal to obtain a second feature, and a second liveness detection result for the detected object is determined based on the second feature.

The first acoustic wave signal is formed by the detected object reflecting a second acoustic wave signal during the process of changing the position of the detected object.

In practice, while the distance between the terminal device and the detected subject is changing, the terminal device may transmit the second acoustic wave signal to the detected object and receive the first acoustic wave signal formed by the reflection of the second acoustic wave signal off the detected object. The second acoustic wave signal may be an ultrasonic wave signal, and the first acoustic wave signal may be an ultrasonic echo signal reflected by the detected object.

In an embodiment, the terminal device transmits a second acoustic wave signal to the detected object at a fixed frequency in a direction from the terminal device towards the detected object through a sound transmitting module such as a speaker, during the period from the time when a first one of the bounding boxes is displayed on the interface to the time when all image frames are obtained. The second acoustic wave signal is reflected by the detected object to form the first acoustic wave signal. The first acoustic wave signal is acquired by the sound acquisition module such as the microphone of the terminal device. In practice, the transmission frequency of the second acoustic wave signal may be set according to actual requirements, for example, to be between 16 KHz to 22 KHz, which is not limited to the embodiment of the present disclosure. Further, the first time-frequency diagram of the first acoustic wave signal is obtained by performing a time-frequency transform, such as a Short-Time Fourier Transform (Short-Time Fourier Transform, STFT), on the first acoustic wave signal obtained by the terminal device. The first time-frequency diagram is an image for representing a change in time and frequency of the first acoustic wave signal. The first time-frequency diagram may include energy values of the first acoustic wave signal at different frequencies.

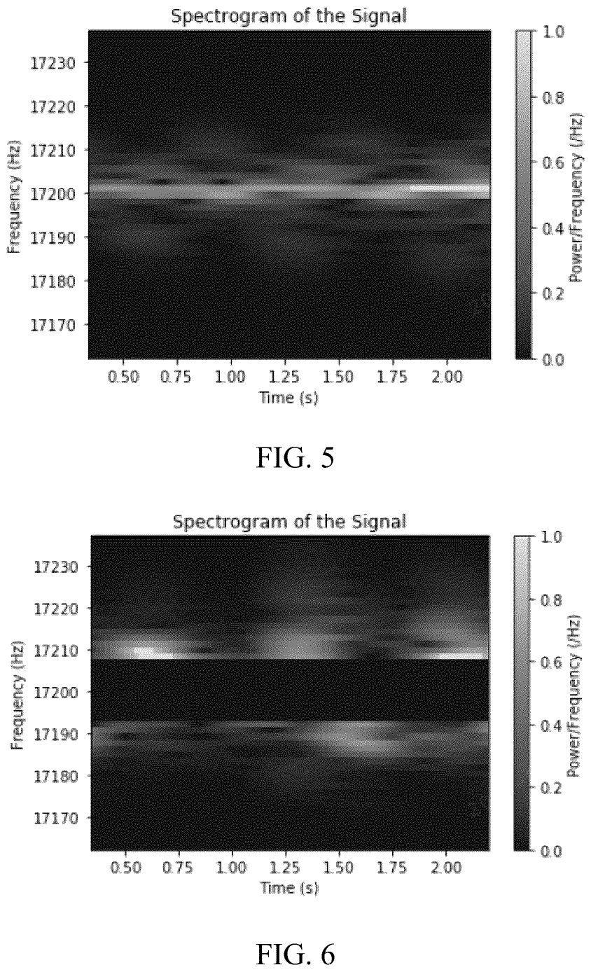

During the process of changing the position of the detected object, under the condition that the detected object is alive, the change in the distance causes the detected object and the terminal device to move relative to each other, thereby causing the frequency of the echo signal reflected by the detected object to be shifted. This phenomenon is referred to as a Doppler shift phenomenon, and may be observed in a time-frequency diagram of the echo signal. Under the condition that the detected object is not alive such as a photograph or a video, the Doppler shift phenomenon does not occur. For example, the second acoustic wave signal is transmitted toward the detected object at a transmission frequency of 17200 Hz and reflected by the detected object to obtain the time-frequency diagram of the first acoustic wave signal as shown in FIG. 5. The horizontal axis in FIG. 5 represents time, the vertical axis on the left represents frequency, and the vertical axis on the right represents energy value. In this time-frequency diagram, the region with the greater energy value represents an increase in the energy value of the echo signal due to the Doppler shift phenomenon. Since the first time-frequency diagram may reflect the frequency offset of the first acoustic wave signal, the second feature extracted from the first time-frequency diagram contains the frequency offset feature of the first acoustic wave signal, and whether the detected object is alive may be determined based on this feature. Since the second feature is obtained based on the time-frequency diagram of the acoustic wave signal, it belongs to the category of the audio feature.

In the above-mentioned Step S204, feature extraction may be performed on the first time-frequency diagram in various suitable ways to obtain the second feature.

In an implementation, the feature extraction is directly performed on the first time-frequency diagram to obtain the second feature.

In another implementation, a first frequency range is determined based on a center frequency of the first time-frequency diagram and a preset frequency, a portion of the energy values within the first frequency range in the first time-frequency diagram is masked to obtain a second time-frequency diagram, and the feature extraction is performed on the second time-frequency diagram to obtain the second feature.

The center frequency is the emission frequency of the second acoustic wave signal. The preset frequency may be set according to actual requirements, which is not limited to the embodiments of the present disclosure. The masking of the energy value refers to setting the energy value to be zero or a less value (e.g., 0.001).

For example, in the first time-frequency diagram shown in FIG. 5 with the center frequency f of 17200 Hz and the preset frequency of 8 Hz, the first frequency ranges are [f−8, f+8], that is, [17192, 17208]. The energy values within the first frequency range are set to zero to obtain the second time-frequency diagram as shown in FIG. 6. Only energy values outside the first frequency range in the first time-frequency diagram are retained in the second time-frequency diagram.

Since the energy value near the center frequency in the first time-frequency diagram is very high, while those at other frequencies are relatively weak, the second feature extracted after the energy values within the first frequency range are masked by the above-described implementation helps to learn the weak frequency shift signal features more easily in the liveness detection process, thereby improving the detection accuracy.

At Step S204, after the second feature is obtained, the second feature is classified to obtain the second liveness detection result for the detected object. The second liveness detection result indicates whether the detected object is alive. For example, the second liveness detection result includes a first score indicating that the detected object is alive and a second score indicating that the detected object is not alive. The greater the first score, the greater the likelihood that the detected object is alive; Similarly, the larger the second score, the greater the likelihood that the detected object is not alive.

The above-described Step S204 may be implemented by a liveness detection model. For example, as shown in FIG. 4, the feature extraction is performed on the first time-frequency diagram by using the second feature extraction network in the liveness detection model to obtain the second feature. The second feature is classified by the second classifier to obtain the second liveness detection result. The second feature extraction network may employ various neural networks having a feature extraction capability, such as a convolutional neural network and the like, which is not limited to the embodiments of the present disclosure. The second classifier may be an MLP. The MLP includes an input layer, a hidden layer, and an output layer with each layer formed by a plurality of neurons. The input layer receives the second feature. The hidden layer performs non-linear transformation on the second feature to obtain the first score indicating that the detected object is alive and the second score indicating that the detected object is not alive, which are also referred to as logits. The output layer converts the first and second scores into a first probability that the detected object is alive and a second probability that the detected object is not alive, respectively. At Step S202, the output result from the hidden layer is determined as the second liveness detection result.

At Step S206, the first feature and the second feature are fused based on the first liveness detection result and the second liveness detection result to obtain a third feature.

The first liveness detection result may reflect the quality of the first feature and the second liveness detection result may reflect the quality of the second feature. Thus, the third feature is obtained by fusing the first feature and the second feature based on the first liveness detection result and the second liveness detection result. A final detection result for the detected object is determined based on the third feature. By using the final detection result for the detected object and the label indicating whether the detected object is alive, the parameters of the liveness detection model are adjusted, so that the liveness detection model may suppress the low-quality feature and is primarily dependent on the high-quality feature, thereby giving full play to the respective advantages of the first feature and the second feature, making the liveness detection model become less susceptible to factors such as the environment in which the detected object is located, the stability of the detection device, etc., and enabling the liveness detection classification to be performed robustly and accurately under various environment while maintaining high generalization capability.

In an implementation, Step S206 includes the first sub-step to the third sub-step as follows.

At the first sub-step, a first confidence level of the first feature is determined based on the first liveness detection result.

At the second sub-step, a second confidence level of the second feature is determined based on the second liveness detection result.

As an example, each of the first liveness detection result and the second liveness detection result includes the first score indicating that the detected object is alive and the second score indicating that the detected object is not alive. In this case, each of the first confidence level and the second confidence level is determined by: performing non-linear mapping on the first score value to obtain a first value; performing non-linear mapping on the second score to obtain a second value; and determining the each of the first confidence level and the second confidence level based on the first value and the second value. The each of the first confidence level and the second confidence level is positively correlated with the sum of the first value and the second value.

In an embodiment, the non-linear mapping on the first or second score is represented by the following formula:

eᵢ=softplus(oᵢ)=log(1+e^{o}^{ᵢ}) (1),

where represents oᵢ score before mapping, eᵢ represents a value after mapping, i=0 or 1, o₀ represents the first score indicating that the detected object is alive, e₀ represents the first value, o₁ represents the second score indicating that the detected object is not alive, e₁ represents the second value, and softplus represents a softplus function.

Each of the first and second confidence levels is determined by the following formula:

Qⱼ=(e₀+e₁)/(2+e₀+e₁) (2),

where Qⱼ represents a confidence level, j=0 or 1, Q₁ represents a first confidence level, and Q₂ represents a second confidence level. It can be seen that for the first feature, if both the first value and the second value in the first liveness detection result are relatively greater, it means that the liveness detection model has relatively strong confidence in the first liveness detection result, which indicates that the quality of the first feature is relatively higher, and the first confidence level is relatively greater (close to 1). On the contrary, if both the first value and the second value in the first liveness detection result are relatively less, it means that the liveness detection model is not confidence in the first liveness detection result, which indicates that the quality of the first feature is lower, and the first confidence is less (close to zero).

Similarly, for the second feature, if both the first value and the second value in the second liveness detection result are relatively greater, it means that the liveness detection model has relatively strong confidence in the second liveness detection result, which indicates that the quality of the second feature is relatively higher, and the second confidence level is relatively greater (close to 1). On the contrary, if both the first value and the second value in the second liveness detection result are relatively less, it means that the liveness detection model is not confidence in the second liveness detection result, which indicates that the quality of the second feature is lower, and the second confidence is less (close to zero).

At the third sub-step, based on the first confidence level and the second confidence level, the first feature and the second feature are fused to obtain the third feature.

In an embodiment, a weight for the first feature is determined based on the first confidence level; a weight for the second feature is determined based on the second confidence level; and a weighted summation is performed on the first feature and the second feature based on the first weight and the second weight to obtain the third feature.

For example, the first confidence level or the product of the first confidence level and a preset positive real number may be determined as the weight for the first feature, and the second confidence level or the product of the second confidence level and the positive real number may be determined as the weight for the second feature. Thus, features with higher confidence levels are assigned greater weights. Consequently, in the fused third feature, higher-quality features contribute more significantly.

For example, the first feature is obtained from an image and is thus susceptible to factors such as ambient light, image definition, and the like. Under the condition that the ambient light or the image definition is poor, the quality of the first feature is also poor. Based on the first liveness detection result, it can be determined that the first confidence level is lower, thereby reducing the weight of the first feature during fusion. Thus, the third feature obtained by fusing helps the liveness detection model to reduce the attention degree to the first feature, thereby weakening the sensitivity to the ambient light and the image definition, and improving the accuracy of the liveness detection. On the contrary, when the ambient light and the image definition are better, the quality of the first feature is also better, and the first confidence level may be determined based on the first liveness detection result, so that the weight for the first feature during feature fusion may be increased. The third feature obtained by the fusion helps the liveness detection model to increase the attention degree to the first feature, thereby giving full play to the advantages of the first feature and improving the accuracy of the liveness detection.

Similarly, the second feature is obtained from the first time-frequency diagram of the first acoustic wave signal and is thus susceptible to factors such as the operational stability of the terminal device, the relative position of the detected object to the terminal device, and the like. In cases of the unstable terminal device (for example, the insufficient emission frequency energy of the second acoustic wave signal or the insufficient frequency shift amplitude of the audio sample), or an unfavorable relative position between the detected object and the terminal device, the first acoustic wave signal is extremely weak, which causes the quality of the second feature to be poor. Based on the second liveness detection result, the second confidence level may be determined to be lower, and the weight for the second feature during the feature fusion may be further reduced. The third feature obtained by fusing helps the liveness detection model to reduce the attention degree to the second feature, thereby weakening the operational stability of the terminal device, reducing the sensitivity of the relative position between the detected object and the terminal device, and improving the accuracy of the liveness detection. On the contrary, when the terminal device operates stably, and the relative position between the detected object and the terminal device is favorable, the quality of the second feature is also good, and the second confidence level may be determined based on the second liveness detection result, so that the weight for the second feature during the feature fusion may be increased. The third feature obtained by fusing helps the liveness detection model to enhance the attention degree to the second feature, thereby giving full play to the advantages of the second feature, and improving the accuracy of the liveness detection.

It can be seen that, instead of simply concatenating the two features, the feature fusion method takes into account the quality of each of the first feature and the second feature, so that the high-quality feature is fully utilized, while the low-quality feature is suppressed, so that the advantages of each of the first feature and the second feature are better realized, the liveness detection model is not easily affected by factors such as the environment in which the detected object is located, the stability of the detection device, etc., and the liveness detection classification may be performed robustly and accurately under various an environment while maintaining high generalization capability.

In another implementation, each of the first liveness detection result and the second liveness detection result includes the first score indicating that the detected object is alive. In this case, the first score is determined as a weight for the feature; a weighted summation is performed on the first feature and the second feature based on the weight for the first feature and the weight for the second feature to obtain the third feature.

Some implementations of Step S206 described above are shown above. It should be understood that the above-mentioned Step S206 may be implemented in other ways, and the present disclosure is not limited thereto.

At Step S208, a third liveness detection result for the detected object is determined based on the third feature.

The third feature is classified to obtain a third liveness detection result for the detected object. The third liveness detection may be used as a final liveness detection result indicating whether the detected object is alive.

The above-described Step S208 may be implemented by a liveness detection model. For example, as shown in FIG. 4, the first feature and the second feature are fused to obtain the third feature, and then third feature is classified by the third classifier to obtain the third liveness detection result. Here, the third classifier may be an MLP. The MLP includes an input layer, a hidden layer, and an output layer with each layer formed by a plurality of neurons. The input layer receives the third feature. The hidden layer performs non-linear transformation on the third feature to obtain the first score indicating that the detected object is alive and the second score indicating that the detected object is not alive, which are also referred to as logits. The output layer converts the first and second scores into a first probability that the detected object is alive and a second probability that the detected object is not alive, respectively. At Step S208, the first probability and the second probability output by the output layer are determined as the third liveness detection result.

In the liveness detection method according to some embodiments of the present disclosure, during the process of changing the position of the detected object, not only an image frame of the detected object is acquired, but also a first acoustic wave signal reflected by the detected object is received. Thereafter, on the one hand, the image frame of the detected object is subjected to feature extraction to obtain the first feature, and the first feature may reflect the key point offset of the detected object, so that the first liveness detection result for the detected object may be determined based on the first feature. On the other hand, the feature extraction is performed on the first time-frequency diagram of the first acoustic wave signal to obtain the second feature. Since the first time-frequency diagram may reflect the frequency offset of the first acoustic wave signal, the second liveness detection result for the detected object may be determined based on the second feature. Further, the first liveness detection result may reflect the quality of the first feature, and the second liveness detection result may reflect the quality of the second feature. The third feature is obtained by fusing the first feature and the second feature, and the third detection result for the detected object is determined based on the third feature. Therefore, the low-quality feature may be suppressed, and the high-quality feature is primarily dependent on the third detection result for the detected object. Thus, the advantages of the first feature and the second feature are fully realized, so that the liveness detection process is not easily affected by factors such as the environment in which the detected object is located, the stability of the detection device, and the like, and the detection accuracy, robustness, and the generalization capability are significantly improved.

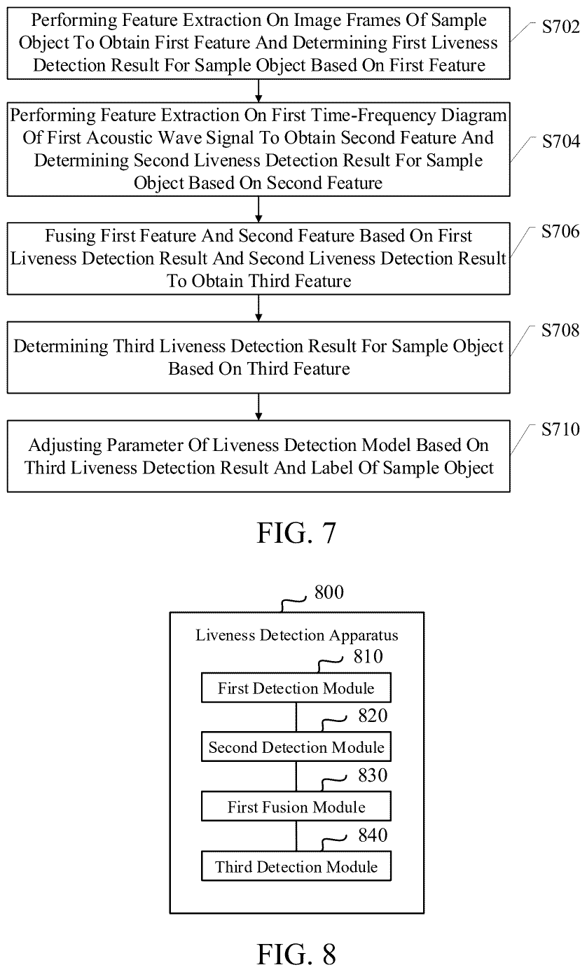

FIG. 7 is a schematic flowchart of a model training method according to some embodiments of the present disclosure. The model training method includes Step S702 to Step S710.

At Step S702, feature extraction is performed on one or more image frames of a sample object to obtain a first feature, and a first liveness detection result for the sample object is determined based on the first feature.

The image frame of the sample object is obtained by performing image acquisition on the sample object in the process of changing the position of the sample object.

The implementation of the above Step S702 is similar to the implementation of Step S202 in the embodiments shown in FIG. 2, and details are not repeatedly described herein.

At Step S704, feature extraction is performed on a first time-frequency diagram of a first acoustic wave signal to obtain a second feature, and a second liveness detection result for the sample object is determined based on the second feature.

The first acoustic wave signal is formed by the sample object reflecting a second acoustic wave signal during the process of changing the position of the sample object.

The implementation of the above Step S704 is similar to the implementation of Step S204 in the embodiment shown in FIG. 2, and details are not repeatedly described.

At Step S706, the first feature and the second feature are fused based on the first liveness detection result and the second liveness detection result to obtain a third feature.

The implementation of the above-mentioned Step S706 is similar to the implementation of S206 in the embodiment shown in FIG. 2, and details are not repeatedly described.

At Step S708, a third liveness detection result for the sample object is determined based on the third feature.

The implementation of the above Step S708 is similar to the implementation of Step S208 in the embodiment shown in FIG. 2, and details are not repeatedly described.

At Step S710, a parameter of the liveness detection model is adjusted based on the third liveness detection result and a label of the sample object.

The label of the sample object indicates whether the sample object is alive.

In an implementation, the loss of the liveness detection model is determined based on a difference between the third liveness detection result and a label of the sample object; and then the parameters of the liveness detection model are adjusted based on the loss.

In another implementation, there may be differences between each of the first liveness detection result and the second liveness detection result for the sample object and the label of the sample object. Thus, in order to improve the accuracy of the two liveness detection results so that the liveness detection model may make better use of the respective advantages of the first feature and the second feature, the Step S710 includes: determining a first loss based on the first liveness detection result for the sample object and the label; determining a second loss based on a second liveness detection result for the sample object and the label; determining a third loss based on the third liveness detection result for the sample object and the label; and adjusting the parameter of the liveness detection model based on the first loss, the second loss, and the third loss.

The first loss reflects the accuracy of the first liveness detection result for the sample object. The second loss reflects the accuracy of the second liveness detection result for the sample object. The third loss reflects the accuracy of the third liveness detection result for the sample object. Each of the first loss, the second loss, and the third loss is calculated by a binary cross entropy loss function.

Further, a weighted sum of the first loss, the second loss, and the third loss is determined as a total loss of the liveness detection model. Then, the parameter of the liveness detection model is adjusted by using a gradient descent algorithm, a back propagation algorithm, and the like, taking the minimized total loss of the model as an optimization target.

The above description provides some implementations of the above-mentioned Step S710. It is to be understood that the above-mentioned Step S710 may be implemented in other ways, and the embodiments of the present disclosure are not limited thereto.

It should be noted that the Step S702 to Step S710 described above are only one round of training of the liveness detection model. In practice, the liveness detection model may be subjected to multiple rounds of training, that is, the above-mentioned Step S702 to Step S710 may be repeatedly performed until the training stopping condition is met. The training stopping condition may be set according to an actual requirement, for example, a requirement that the number of the rounds of training reaches a preset threshold or that a total loss of a liveness detection model converges, which is not limited in the embodiments of the present disclosure.

In the liveness detection method according to some embodiments of the present disclosure, during the process of changing the position of the sample object, not only an image frame of the sample object is acquired, but also a first acoustic wave signal reflected by the sample object is received. Thereafter, on the one hand, the image frame of the sample object is subjected to feature extraction to obtain the first feature, and the first feature may reflect the key point offset of the sample object, so that the first liveness detection result for the sample object may be determined based on the first feature. On the other hand, the feature extraction is performed on the time-frequency diagram of the first acoustic wave signal to obtain the second feature. Since the time-frequency diagram may reflect the frequency offset of the first acoustic wave signal, the second liveness detection result for the sample object may be determined based on the second feature. Further, the first liveness detection result may reflect the quality of the first feature, and the second liveness detection result may reflect the quality of the second feature. The third feature is obtained by fusing the first feature and the second feature, and the third detection result for the sample object is determined based on the third feature, the third liveness detection result for the sample object indicates whether the sample object is alive and is used to adjust the parameter of the liveness detection model, so that the liveness detection model may suppress low-quality features and primarily dependent on high-quality features. Thus, the advantages of the first feature and the second feature are fully realized, so that the liveness detection model is not easily affected by factors such as the environment in which the sample object is located, the stability of the detection device, and the like, and the liveness detection model may perform liveness detection robustly and accurately under various an environment and exhibits high generalization capability.

Some embodiments of the present disclosure have been described above. Other embodiments are within the scope of the appended claims. In some cases, the operations or operations recited in the claims may be performed in an order different from that in the embodiments and the expected results may still be achieved. In addition, the processes depicted in the drawings do not necessarily require the particular order or sequential order shown to achieve the desired results. In certain embodiments, multitasking and parallel processing are also possible or may be advantageous.

An embodiment of the present disclosure further provides a liveness detection apparatus based on the same inventive concept as the liveness detection method shown in FIG. 2. Referring to FIG. 8, FIG. 8 is a schematic block diagram of a liveness detection apparatus 800 according to some embodiments of the present disclosure. The liveness detection apparatus 800 includes a first detection module 810, a second detection module 820, a first fusion module 830, and a third detection module 840.

The first detection module 810 is configured to perform feature extraction on one or more image frames of a detected object to obtain a first feature and determining a first liveness detection result for the detected object based on the first feature, where the one or more image frames are obtained by acquiring an image of the detected object during a process of changing a position of the detected object.

The second detection module 820 is configured to perform feature extraction on a first time-frequency diagram of a first acoustic wave signal to obtain a second feature and determining a second liveness detection result for the detected object based on the second feature, where the first acoustic wave signal is formed by the detected object reflecting a second acoustic wave signal during the process of changing the position of the detected object.

The first fusion module 830 is configured to fuse the first feature and the second feature based on the first liveness detection result and the second liveness detection result to obtain a third feature.

The third detection module 840 is configured to determine a third liveness detection result for the detected object based on the third feature.

In an embodiment, the first fusion module is configured to: determine a first confidence level of the first feature based on the first liveness detection result; determine a second confidence level of the second feature based on the second liveness detection result; and fuse the first feature and the second feature based on the first confidence level and the second confidence level to obtain the third feature.

In other embodiments, each of the first liveness detection result and the second liveness detection result includes a first score indicating that the detected object is alive and a second score indicating that the detected object is not alive. Each of the first confidence and the second confidence is determined by:
performing non-linear mapping on the first score value to obtain a first value;
performing non-linear mapping on the second score to obtain a second value;
determining the each of the first confidence level and the second confidence level based on the first value and the second value, where the each of the first confidence level and the second confidence level is positively correlated with a sum of the first value and the second value.

In other embodiments, the first fusion module performs the following operations in the fusing of the first feature and the second feature based on the first confidence level and the second confidence level to obtain the third feature:
determining the first confidence level as a first weight of the first feature;
determining the second confidence level as a second weight of the second feature;
obtaining a weighted sum of the first feature and the second feature based on the first weight and the second weight to obtain the third feature.

In other embodiments, the one or more image frames include a plurality of image frames, and the plurality of the image frames are obtained by performing the image acquisition on the detected object at different positions. When the first detection module performs feature extraction on the image frame of the detected object to obtain the first feature, the first detection module performs the following operations:
extracting first key point data of the detected object from the one or more image frames, respectively;
concatenating the first key point data respectively corresponding to the one or more image frames according to an order of respective timestamps of the one or more image frames to obtain second key point data;
performing the feature extraction on the second key point data to obtain the first feature.

In other embodiments, the first time-frequency diagram includes energy values of the first acoustic wave signal at different frequencies;

The second detection module performs the operations of:
determining a first frequency range based on a center frequency of the first time-frequency diagram and a preset frequency;
masking a portion of the energy values within the first frequency range in the first time-frequency diagram to obtain a second time-frequency diagram;
performing the feature extraction on the second time-frequency diagram to obtain the second feature.

The liveness detection apparatus according to some embodiments of the present disclosure may be used as the execution body of the liveness detection method shown in FIG. 2. For example, in the liveness detection method shown in FIG. 2, Step S202 may be performed by the first detection module 810 in the liveness detection apparatus shown in FIG. 8, Step S204 may be performed by the second detection module 820 in the liveness detection apparatus shown in FIG. 8, Step S206 may be performed by the first fusion module 830 in the liveness detection apparatus shown in FIG. 8, and Step S208 may be performed by the third detection module 840 in the liveness detection apparatus shown in FIG. 8.

According to another embodiment of the present disclosure, each of the modules in the liveness detection apparatus shown in FIG. 8 may be separately or all combined into one or several additional modules, or one or more of the modules may be subdivided into a plurality of modules with more specific functions, which may perform the same operation without affecting the implementation of the technical effect of the embodiments of the present disclosure. The above-mentioned units are divided based on logical functions. In practice, the functions of one module may be implemented by multiple modules, or the functions of multiple modules may be implemented by one module. In the embodiment of the present disclosure, the liveness detection apparatus may further include other modules, which may be implemented with the assistance of other modules in practical applications, and may be implemented in cooperation with a plurality of modules.

According to another embodiment of the present disclosure, the liveness detection apparatus shown in FIG. 8 may be constructed and the liveness detection method of the embodiment of the present disclosure may implemented by running a computer program (including program codes) capable of executing the operations involved in the corresponding method shown in FIG. 2 on a general-purpose computing device such as a computer including a processing element such as a Central Processing Unit (CPU), a Random Access Memory (RAM), a Read-Only Memory (ROM), and the like, and a storage element. The computer program may be recorded on, for example, a computer-readable storage medium and transferred to and executed in an electronic device by the computer-readable storage medium.

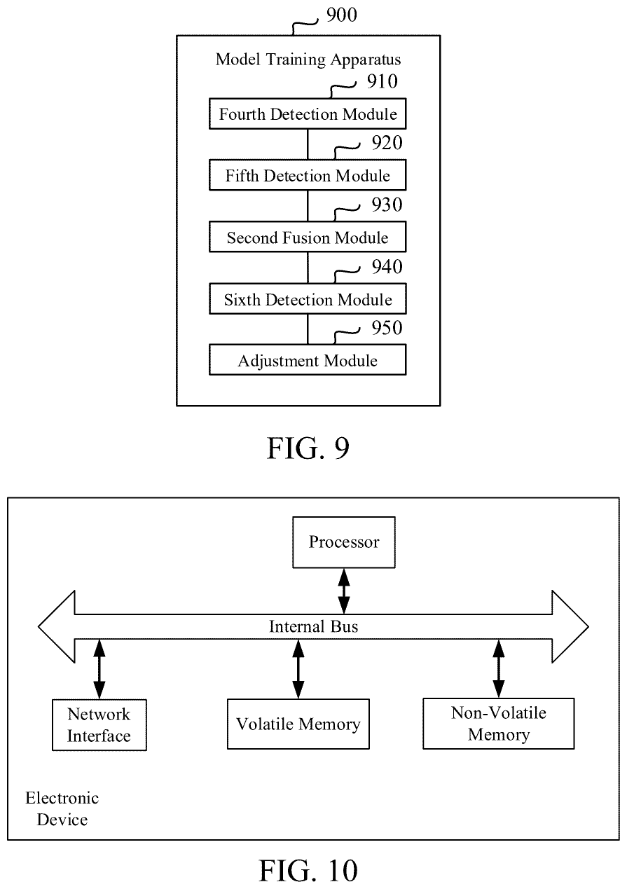

An embodiment of the present disclosure further provides a model training apparatus based on the same inventive concept as the model training method shown in FIG. 7. Referring to FIG. 9, the model training apparatus 900 according to some embodiments of the present disclosure includes a fourth detection module 910, a fifth detection module 920, a second fusion module 930, a sixth detection module 940, and an adjustment module 950.

The fourth detection module 910 is configured to perform feature extraction on one or more image frames of a sample object to obtain a first feature and determine a first liveness detection result for the sample object based on the first feature, where the one or more image frames are obtained by acquiring an image of the sample object during a process of changing a position of the sample object.

The fifth detection module 920 is configured to perform feature extraction on a first time-frequency diagram of a first acoustic wave signal to obtain a second feature and determine a second liveness detection result for the sample object based on the second feature, where the first acoustic wave signal is formed by the sample object reflecting a second acoustic wave signal during the process of changing the position of the sample object.

The second fusion module 930 is configured to fuse the first feature and the second feature based on the first liveness detection result and the second liveness detection result to obtain a third feature.

The sixth detection module 940 is configured to determine a third liveness detection result for the sample object based on the third feature.

The adjustment module 950 is configured to adjust a parameter of a liveness detection model based on the third liveness detection result and a label of the sample object, the label indicating whether the sample object belongs to a liveness detection.

In other embodiments, the adjustment module is configured to:
determine a first loss based on the first liveness detection result and the label;
determine a second loss based on the second liveness detection result and the label;
determine a third loss based on the third liveness detection result and the label; and
adjust the parameter of the liveness detection model based on the first loss, the second loss, and the third loss.

The model training apparatus according to some embodiments of the present disclosure may be used as an execution body of the model training method shown in FIG. 7. For example, in the model training method shown in FIG. 7, Step S702 may be performed by the fourth detection module 910 in the model training apparatus shown in FIG. 9, Step S704 may be performed by the fifth detection module 920 in the model training apparatus shown in FIG. 9, Step S706 may be performed by the second fusion module 930 in the model training apparatus shown in FIG. 9, Step S708 may be performed by the sixth detection module 940 in the model training apparatus shown in FIG. 9, and Step S710 may be performed by the adjustment module 950 in the model training apparatus shown in FIG. 9.

According to another embodiment of the present disclosure, each of the modules in the model training apparatus shown in FIG. 9 may be separately or all combined into one or several additional modules, or one or more of the modules may be subdivided into a plurality of modules with more specific functions, which may perform the same operation without affecting the implementation of the technical effect of the embodiments of the present disclosure. The above-mentioned units are divided based on logical functions. In practice, the functions of one module may be implemented by multiple modules, or the functions of multiple modules may be implemented by one module. In the embodiment of the present disclosure, the model training apparatus may further include other modules, which may be implemented with the assistance of other modules in practical applications, and may be implemented in cooperation with a plurality of modules.

According to another embodiment of the present disclosure, the model training apparatus shown in FIG. 9 may be constructed and the model training method of the embodiment of the present disclosure may implemented by running a computer program (including program code) capable of executing the operations involved in the corresponding method shown in FIG. 7 on a general-purpose computing device such as a computer including a processing element such as a Central Processing Unit (CPU), a Random Access Memory (RAM), a Read-Only Memory (ROM), and the like, and a storage element. The computer program may be recorded on, for example, a computer-readable storage medium and transferred to and executed in an electronic device by the computer-readable storage medium.

FIG. 10 is a schematic block diagram of an electronic device according to some embodiments of the present disclosure. Referring to FIG. 10, at the hardware level, the electronic device includes a processor, or further includes an internal bus, a network interface, and a memory. The memory may include a volatile memory, such as a Random-Access Memory (RAM), or may include a non-volatile memory, such as at least one disk memory. The electronic device may further include hardware required for other services.

The processor, the network interface, and the memory may be interconnected by an internal bus, which may be an ISA (Industry Standard Architecture) bus, a PCI (Peripheral Component Interconnect) bus, or an EISA (Extended Industry Standard Architecture) bus, etc. The bus may be divided into an address bus, a data bus, a control bus, and the like. For ease of illustration, only one bi-directional arrow is shown in FIG. 10, but it does not indicate that there is only one bus or one type of bus in FIG. 10.

A memory is configured to store the program. For example, the program may include program code including computer operation instructions. The memory may include a volatile memory and a non-volatile memory, and provides instructions and data to the processor.

The processor reads the corresponding computer program from the non-volatile memory into the memory and then runs it to form the liveness detection apparatus at a logical level. The processor that executes the program stored in the memory and specifically performs the following operations:
performing feature extraction on one or more image frames of a detected object to obtain a first feature and determining a first liveness detection result for the detected object based on the first feature, where the one or more image frames are obtained by acquiring an image of the detected object during a process of changing a position of the detected object;
performing feature extraction on a first time-frequency diagram of a first acoustic wave signal to obtain a second feature and determining a second liveness detection result for the detected object based on the second feature, where the first acoustic wave signal is formed by the detected object reflecting a second acoustic wave signal during the process of changing the position of the detected object;
fusing the first feature and the second feature based on the first liveness detection result and the second liveness detection result to obtain a third feature; and
determining a third liveness detection result for the detected object based on the third feature.

Alternatively, the processor reads the corresponding computer program from the non-volatile memory to the memory and then runs it to form the model training device at the logical level. The processor that executes the program stored in the memory and specifically performs the following operations:
performing feature extraction on one or more image frames of a sample object to obtain a first feature and determining a first liveness detection result for the sample object based on the first feature, where the one or more image frames are obtained by acquiring an image of the sample object during a process of changing a position of the sample object;
performing feature extraction on a first time-frequency diagram of a first acoustic wave signal to obtain a second feature and determining a second liveness detection result for the sample object based on the second feature, where the first acoustic wave signal is formed by the sample object reflecting a second acoustic wave signal during the process of changing the position of the sample object;
fusing the first feature and the second feature based on the first liveness detection result and the second liveness detection result to obtain a third feature;
determining a third liveness detection result for the sample object based on the third feature; and
adjusting a parameter of a liveness detection model based on the third liveness detection result and a label of the sample object, the label indicating whether the sample object is alive.

The above-described method performed by the liveness detection apparatus disclosed in the embodiment shown in FIG. 2 of the present disclosure, or the above-described method performed by the model training apparatus disclosed in the embodiment shown in FIG. 7 of the present disclosure, may be applied to or implemented by a processor. The processor may be an integrated circuit chip having signal processing capabilities. In an implementation, the operations of the above method may be performed by integrated logic circuits of hardware in the processor or by instructions in the form of software. The processor may include a general-purpose processor, including a Central Processing Unit (CPU), a Network Processor (NP), and the like. It may include a Digital Signal Processor (DSP), an Application Specific Integrated Circuit (ASIC), a Field-Programmable Gate Array (FPGA) or other programmable logic device, a discrete gate or transistor logic device, a discrete hardware component. The methods, operations, and logical block diagrams disclosed in the embodiments of the present disclosure may be implemented or performed. The general purpose processor may be a microprocessor or the processor may be any conventional processor or the like. The operations of the method disclosed in connection with the embodiment of the present disclosure may be directly performed by a hardware decoding processor, or performed by a combination of hardware and software modules in the decoding processor. The software module may be located in a storage medium mature in the art such as a random access memory, a flash memory, a read-only memory, a programmable read-only memory, or an electrically erasable programmable memory, a register, or the like. The storage medium is located in a memory, and the processor reads information in the memory to perform the operations of the above method in conjunction with its hardware.

The electronic device may perform the method of FIG. 2 and implement the functions of the liveness detection apparatus in the embodiments shown in FIGS. 2 and 3, or the electronic device may perform the method of FIG. 7 and implement the functions of the model training apparatus in the embodiments shown in FIG. 7. The embodiments of the present disclosure are not described herein.

The electronic device in the present disclosure does not have other implementations other than a software implementation, such as a logic device or a combination of software and hardware, which means that the execution body of the following process flow is not limited to the respective logic unit, but may be hardware or a logic device.

An embodiment of the present disclosure further provides a computer-readable storage medium storing one or more programs including instructions that, when executed by an electronic device including a plurality of application programs, enable the electronic device to perform the method according to the embodiment shown in FIG. 2, and specifically for performing the following operations:
performing feature extraction on one or more image frames of a detected object to obtain a first feature and determining a first liveness detection result for the detected object based on the first feature, where the one or more image frames are obtained by acquiring an image of the detected object during a process of changing a position of the detected object;
performing feature extraction on a first time-frequency diagram of a first acoustic wave signal to obtain a second feature and determining a second liveness detection result for the detected object based on the second feature, where the first acoustic wave signal is formed by the detected object reflecting a second acoustic wave signal during the process of changing the position of the detected object;
fusing the first feature and the second feature based on the first liveness detection result and the second liveness detection result to obtain a third feature; and
determining a third liveness detection result for the detected object based on the third feature.

Alternatively, the instruction, when executed by an electronic device including a plurality of application programs, enables the electronic device to perform the method according to the embodiment shown in FIG. 7, and specifically to perform the following operations:
performing feature extraction on one or more image frames of a sample object to obtain a first feature and determining a first liveness detection result for the sample object based on the first feature, where the one or more image frames are obtained by acquiring an image of the sample object during a process of changing a position of the sample object;
performing feature extraction on a first time-frequency diagram of a first acoustic wave signal to obtain a second feature and determining a second liveness detection result for the sample object based on the second feature, where the first acoustic wave signal is formed by the sample object reflecting a second acoustic wave signal during the process of changing the position of the sample object;
fusing the first feature and the second feature based on the first liveness detection result and the second liveness detection result to obtain a third feature; and
determining a third liveness detection result for the sample object based on the third feature; and
adjusting a parameter of a liveness detection model based on the third liveness detection result and a label of the sample object, the label indicating whether the sample object is alive.

Embodiments of the present disclosure further provide a computer program product including a non-transitory computer-readable storage medium storing a computer program operable to enable a computer to perform some or all of the operations in the liveness detection method or the model training method according to some embodiments of the present disclosure.

In summary, the foregoing description is only some embodiments of the present disclosure and is not intended to limit the scope of the present disclosure. Any modifications, equivalents, modifications, etc. which fall within the spirit and principles of the present disclosure are intended to be included within the scope of the present disclosure.

The system, apparatus, module or unit set forth in the above embodiments may be embodied by a computer chip or entity or by a product having a certain function. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device, or a combination of any of these devices.

Computer-readable media, including permanent and non-permanent, removable and non-removable media, may be implemented for information storage by any method or technique. The information may be computer-readable instructions, data structures, modules of a program, or other data. Examples of storage media for computers include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only optical disk read-only memory (CD-ROM), digital versatile disks (DVD) or other optical storage, magnetic cassette tape, magnetic disk storage or other magnetic storage devices, or any other non-transmission medium that may be used to store information that may be accessed by a computing device. As defined herein, a computer-readable medium does not include a transitory media, such as a modulated data signal and a carrier wave.

It is also noted that the terms “comprise”, “include” and any other variation thereof are intended to cover a non-exclusive inclusion, such that a process, method, article, or device that includes a list of elements includes not only those elements but also other elements not expressly listed, or further includes elements inherent to such process, method, article, or apparatus. Without more limitations, elements defined by the statement “include a . . . ” do not rule out there are additional identical elements in the process, method, article, or apparatus including said elements.

Some embodiments of the present disclosure have been described in detail above. The description of the above embodiments merely aims to facilitate understanding of the present disclosure. Many modifications or equivalent substitutions with respect to the embodiments may occur to those of ordinary skill in the art. Thus, these modifications or equivalent substitutions shall fall within the scope of the present disclosure.

What is claimed is:

1. A liveness detection method, comprising:
performing feature extraction on one or more image frames of a detected object to obtain a first feature, and determining a first liveness detection result for the detected object based on the first feature, wherein the one or more image frames are obtained by acquiring an image of the detected object during a process of changing a position of the detected object;
performing feature extraction on a first time-frequency diagram of a first acoustic wave signal to obtain a second feature, and determining a second liveness detection result for the detected object based on the second feature, wherein the first acoustic wave signal is formed by the detected object reflecting a second acoustic wave signal during the process of changing the position of the detected object;
fusing the first feature and the second feature based on the first liveness detection result and the second liveness detection result to obtain a third feature; and
determining a third liveness detection result for the detected object based on the third feature.

2. The liveness detection method of claim 1, wherein the fusing of the first feature and the second feature based on the first liveness detection result and the second liveness detection result comprises to obtain the third feature comprises:
determining a first confidence level of the first feature based on the first liveness detection result;
determining a second confidence level of the second feature based on the second liveness detection result; and
fusing the first feature and the second feature based on the first confidence level and the second confidence level to obtain the third feature.

3. The liveness detection method of claim 2, wherein the first liveness detection result comprises a first first score indicating that the detected object is alive and a first second score indicating that the detected object is not alive, and the second liveness detection result comprises a second first score indicating that the detected object is alive and a second second score indicating that the detected object is not alive;
the determining of the first confidence level based on the first liveness detection result comprises:
performing non-linear mapping on the first first score value to obtain a first first value;
performing non-linear mapping on the first second score to obtain a first second value; and
determining the first confidence level based on the first first value and the first second value, wherein the first confidence level is positively correlated with a sum of the first first value and the first second value; and
the determining of the second confidence level based on the second liveness detection result comprises:
performing non-linear mapping on the second first score value to obtain a second first v alue;
performing non-linear mapping on the second second score to obtain a second second value; and
determining the second confidence level based on the second first value and the second second value, wherein the second confidence level is positively correlated with a sum of the second first value and the second second value.

4. The liveness detection method of claim 2, wherein the fusing of the first feature and the second feature based on the first confidence level and the second confidence level to obtain the third feature comprises:
determining the first confidence level as a first weight of the first feature;
determining the second confidence level as a second weight of the second feature; and
calculating a weighted sum of the first feature and the second feature based on the first weight and the second weight to obtain the third feature.

5. The liveness detection method of claim 1, wherein the one or more image frames comprise a plurality of image frames obtained by acquiring images of the detected object located at respective positions; and
the performing of the feature extraction on the one or more image frames to obtain the first feature comprises:
extracting first key point data of the detected object from the plurality of image frames, respectively;
concatenating, based on an order of respective timestamps of the plurality of image frames, the first key point data respectively corresponding to the plurality of image frames, to obtain second key point data; and
performing feature extraction on the second key point data to obtain the first feature.

6. The liveness detection method of claim 1, wherein the first time-frequency diagram comprises energy values of the first acoustic wave signal at respective frequencies; and
the performing of the feature extraction on the first time-frequency diagram to obtain the second feature comprises:
determining a first frequency range based on a center frequency of the first time-frequency diagram and a preset frequency;
masking a portion of the energy values within the first frequency range in the first time-frequency diagram to obtain a second time-frequency diagram; and
performing feature extraction on the second time-frequency diagram to obtain the second feature.

7. A model training method, comprising:
performing feature extraction on one or more image frames of a sample object to obtain a first feature, and determining a first liveness detection result for the sample object based on the first feature, wherein the one or more image frames are obtained by acquiring an image of the sample object during a process of changing a position of the sample object;
performing feature extraction on a first time-frequency diagram of a first acoustic wave signal to obtain a second feature, and determining a second liveness detection result for the sample object based on the second feature, wherein the first acoustic wave signal is formed by the sample object reflecting a second acoustic wave signal during the process of changing the position of the sample object;
fusing the first feature and the second feature based on the first liveness detection result and the second liveness detection result to obtain a third feature;
determining a third liveness detection result for the sample object based on the third feature; and
adjusting a parameter of a liveness detection model based on the third liveness detection result and a label of the sample object indicating whether the sample object is alive.

8. The model training method of claim 7, wherein the adjusting of the parameter of the liveness detection model based on the third liveness detection result and the label comprises:
determining a first loss based on the first liveness detection result and the label;
determining a second loss based on the second liveness detection result and the label;
determining a third loss based on the third liveness detection result and the label; and
adjusting the parameter of the liveness detection model based on the first loss, the second loss, and the third loss.

9. An electronic device, comprising:
a processor; and
a memory storing instructions executable by the processor to perform operations comprising:
performing feature extraction on one or more image frames of a detected object to obtain a first feature, and determining a first liveness detection result for the detected object based on the first feature, wherein the one or more image frames are obtained by acquiring an image of the detected object during a process of changing a position of the detected object;
performing feature extraction on a first time-frequency diagram of a first acoustic wave signal to obtain a second feature, and determining a second liveness detection result for the detected object based on the second feature, wherein the first acoustic wave signal is formed by the detected object reflecting a second acoustic wave signal during the process of changing the position of the detected object;
fusing the first feature and the second feature based on the first liveness detection result and the second liveness detection result to obtain a third feature; and
determining a third liveness detection result for the detected object based on the third feature.

10. The electronic device of claim 9, wherein the fusing of the first feature and the second feature based on the first liveness detection result and the second liveness detection result comprises to obtain the third feature comprises:
determining a first confidence level of the first feature based on the first liveness detection result;
determining a second confidence level of the second feature based on the second liveness detection result; and
fusing the first feature and the second feature based on the first confidence level and the second confidence level to obtain the third feature.

11. The electronic device of claim 10, wherein the first liveness detection result comprises a first first score indicating that the detected object is alive and a first second score indicating that the detected object is not alive, and the second liveness detection result comprises a second first score indicating that the detected object is alive and a second second score indicating that the detected object is not alive;
the determining of the first confidence level based on the first liveness detection result comprises:
performing non-linear mapping on the first first score value to obtain a first first value;
performing non-linear mapping on the first second score to obtain a first second value; and
determining the first confidence level based on the first first value and the first second value, wherein the first confidence level is positively correlated with a sum of the first first value and the first second value; and
the determining of the second confidence level based on the second liveness detection result comprises:
performing non-linear mapping on the second first score value to obtain a second first v alue;
performing non-linear mapping on the second second score to obtain a second second value; and
determining the second confidence level based on the second first value and the second second value, wherein the second confidence level is positively correlated with a sum of the second first value and the second second value.

12. The electronic device of claim 10, wherein the fusing of the first feature and the second feature based on the first confidence level and the second confidence level to obtain the third feature comprises:
determining the first confidence level as a first weight of the first feature;
determining the second confidence level as a second weight of the second feature; and
calculating a weighted sum of the first feature and the second feature based on the first weight and the second weight to obtain the third feature.

13. The electronic device of claim 9, wherein the one or more image frames comprise a pl urality of image frames obtained by acquiring images of the detected object located at respective positions; and
the performing of the feature extraction on the one or more image frames to obtain the first feature comprises:
extracting first key point data of the detected object from the plurality of image frames, respectively;
concatenating, based on an order of respective timestamps of the plurality of image frames, the first key point data respectively corresponding to the plurality of image frames, to obtain second key point data; and
performing feature extraction on the second key point data to obtain the first feature.

14. The electronic device of claim 9, wherein the first time-frequency diagram comprises energy values of the first acoustic wave signal at respective frequencies; and
the performing of the feature extraction on the first time-frequency diagram to obtain the second feature comprises:
determining a first frequency range based on a center frequency of the first time-frequency diagram and a preset frequency;
masking a portion of the energy values within the first frequency range in the first time-frequency diagram to obtain a second time-frequency diagram; and
performing feature extraction on the second time-frequency diagram to obtain the second feature.

15. An electronic device, comprising:
a processor; and
a memory storing instructions executable by the processor to perform the model training method of claim 7.

16. The electronic device of claim 15, wherein the adjusting of the parameter of the liveness detection model based on the third liveness detection result and the label comprises:
determining a first loss based on the first liveness detection result and the label;
determining a second loss based on the second liveness detection result and the label;
determining a third loss based on the third liveness detection result and the label; and
adjusting the parameter of the liveness detection model based on the first loss, the second loss, and the third loss.

17. A non-transitory computer-readable storage medium storing instructions executable by a processor of an electronic device to perform the liveness detection method of claim 1.

18. A non-transitory computer-readable storage medium storing instructions executable by a processor of an electronic device to perform the model training method of claim 7.
